(19) United States
(12) Patent Application Publication
(10) Pub. No.: US 2012/0228283 A1
(43) Pub. Date: Sep. 13, 2012

(54) OHMIC DEFROSTER FOR FOODS AND PROCESS

(76) Inventors: Oscar Alberto Ochoa Gonzalez, Medellin (CO); Hader Norvey Gomez Gomez, Medellin (CO); Carlos Fernando Diosa Quintero, Medellin (CO); Juan Guillermo Puerta, Medellin (CO)

(21) Appl. No.: 13/394,866

(22) PCT Filed: Aug. 9, 2010
(86) PCT No.: PCT/IB2010/001969

§ 371 Date: May 22, 2012

(30) Foreign Application Priority Data
Sep. 9, 2009 (CO) 09 096358

(51) Int. Cl. B23K 13/08

(52) U.S. Cl. 219/482

(57) ABSTRACT

The defrosting apparatus of the present invention uses ohmic heating as operating principle, circulating an electric current through blocks of food. In the particular case of foods, electric current conduction capacity is low, which means that energy is dissipated into the material in the form of heat, thereby heating same. In this case, the block of frozen food acts as a resistor in the electrical circuit which opposes the passage of the current. The defrosting apparatus of the present invention generally comprises a plurality of compartments for receiving blocks of frozen food and for connecting said blocks to an electrical circuit by means of electrodes. In addition, the apparatus includes a plurality of heating modules, a module for controlling and monitoring variables, a plurality of power modules for supplying the necessary electrical energy, and a plurality of pneumatic modules for guaranteeing contact between the blocks of food and the electrodes of the power system. The heating modules are designed to receive the frozen blocks of food and to supply the electrical energy necessary to heat the material and to obtain the required temperature. The defrosting apparatus comprises a plurality of heating modules, depending on the capacity required and on the geometry of the blocks of food to be defrosted, and the number of modules may be between four and eight, but is not limited thereto. The module for controlling and monitoring variables is designed to record the behaviour of the variables that play a role in the defrosting process and the operation of the equipment. The equipment includes a single system that governs the entire operation thereof. The defrosting process for blocks of frozen foods is characterized by (i) placing the block of frozen food in a plurality of compartments, (ii) connecting said block to an electrical circuit by means of electrodes, (iii) guaranteeing contact between the frozen block of food and the electrodes, and (iv) circulating an electric current through the block of frozen food. Said electric current is that which is necessary to heat the frozen block of food and to obtain the necessary temperature.

### FIELD OF THE INVENTION

The present invention is related in general to a defroster for food products, specifically to a defroster whose principle of operation is ohmic heating, which consists in causing an electric current to flow through the material that is to be defrosted, as well as the defrosting process.

### STATE OF THE ART

In the perishable food preparation industry it is a common practice to freeze the materials for the purpose of preserving their quality during the storage periods that are required in industrial processes. This practice arises out of the need to guarantee the inventories of raw materials for supplying high-volume productive processes and transportation of the products to consumption centers that are distant from the production centers, and so on.

In some cases the materials that have been frozen must be defrosted in order to allow for their transformation during the production process and their consumption as a finished product. In order to carry out this activity, currently traditional technologies are used such as: forced hot air convection chambers and massage drums, which present certain operative disadvantages and difficulties.

The forced hot air convection chamber is the technology most used in the food industry for defrosting their materials. This technology consists in subjecting the blocks of foods to high-speed, high-temperature air currents; contact with the air current causes heating of the surface of the block from which the energy flows into its interior, in this way ensuring that the ice crystals will melt and the material will achieve the defrosting conditions. The operational principle of this technology is heat transference by convection between the air flow and the material.

Defrosting by forced hot air convection has the disadvantage, in the case of defrosting of blocks of food, that during the process, differences in high temperatures between the surface and the thermic center of the block occur. This situation presents itself because of the low thermic conductivity that characterizes foods and which limits heat flow between the surface of the block and its thermic center.

The system must use operational parameters adjusted so that the surface temperature does not remain high and cause the material to deteriorate before the block in process has completely defrosted. The consequence of controlling this phenomenon is to have prolonged process times. In the case of blocks of meat that start the process at temperatures around −15° C., that time is between 18 and 20 hours.

Another disadvantage of forced convection systems is the high percentage of losses of material that occur in defrosting materials with a high water content, as is the case with foods. This situation occurs because the surface reaches temperatures above the point of fusion, causing the ice crystals in the material to melt.

The configuration of the equipment utilized for applying this technology causes leakage of the liquids produced by defrosting, which then flow into the public sewage system, affecting the environment.

For its part, the massage drum is a technology that utilizes direct contact of the frozen material with the hot surface of a moving drum, which also strikes the material found inside it, causing its temperature to rise and in this way also causing the ice crystals to melt, achieving the defrosting conditions. The operational principle of this technology is heat transfer by conduction between the hot surface of the drum and the material being processed.

The massage drum technology has a disadvantage just like the process described above, that when blocks of food are being defrosted, differences of high temperatures arise between the surface and the thermic center of the block. This is caused by the low thermic conductivity of some foods, which limits heat flow between the surface and the thermic center. Its difference from the foregoing technology resides in the mechanism used to transfer heat to the material, in this case it is by conduction and in the other technology, by convection.

Like the first system, this system must utilize operational parameters adjusted so as to prevent the temperature of the interior surface from being high, resulting in the deterioration of the material before the blocks in the process are completely defrosted. Consequently, the process times are prolonged. In the case of blocks of meat that start the process at temperatures around −15° C., that time is around 9 hours.

Well then, taking into account the technical disadvantages and difficulties of traditional techniques, in recent years technologies have been developing that use different principles of operation. These technologies use principles such as: supplying high-frequency energy, among them microwaves and radio frequency and ohmic heating (Barbosa-Cánovas, 1999; Aymerich, T., Picouet, P. A., Monfort, J. M, 2008; Piette et al., 2008).

Heating by radio frequency has been employed principally in microbe inactivation in materials that are liquid, solid and a mixture of the two states. Said technology uses tunnels that have been efficient as much for inactivation of microbes as for reducing the heating time of foods. Given the efficiency in heating that this technology offers, it has been utilized at the industrial level for different processes among them defrosting foods. (Aymerich, T., Picouet, P. A., Monfort, J. M, 2008; Piette et al., 2008).

On the other hand, microwave technology is one of the technologies used for heating at the industrial level with high levels of efficiency in processes of partial defrosting of blocks of various types of meat and shoulder, pasteurization of foods, bread that has been prebaked and packaged and for drying grains (Ohlsson, T. and Bengtsson, N., 2002). What limits the application of this technology is the percentage of water contained in the product to be heated. In the particular case of defrosting blocks of meat and shoulder, it has less efficiency because of the initial solid state of the water, which does not allow the water molecules to move freely.

In the case of high-frequency heating, a high-frequency current is used that generates molecular movement in materials that are poor conductors of the current by means of capacitive fields. Different frequencies are used, dependent upon the material to be heated. The material to be heated is placed between two metal plates that form a capacitor, a high-frequency voltage is applied to these, and in this way the material between the plates is heated by the molecular movement caused by the capacitive field. The working principle of this technology is heating by moving the particles of material (Aymerich, T., Picouet, P. A., Monfort, J. M, 2008; Piette et al., 2008). Patent WO 00/51450 refers to a device for defrosting foods quickly and uniformly, using said high-frequency electric energy.

In the case of ohmic heating, this has been utilized with success in materials in the liquid state and liquids with solid particles. Not many studies are known on the application of this technology at the industrial level in solid materials (Aymerich, T., Picouet, P. A., Monfort, J. M, 2008; Piette et al., 2008). Ohmic heating, unlike the two technologies described above, has not been used for defrosting foods, probably because its application has been centered on liquid materials and liquids containing solid particles.

### PURPOSE OF THE INVENTION

The invention was developed as a response to an ancient, permanent and unsatisfied need that would resolve the problems inherent in the previous art. Thus, the objective of the present invention is to provide an apparatus for defrosting food products that utilizes ohmic heating and its defrosting process as its operational principle.

The principal benefits to be gained with this new technology are a reduction in the loss of material due to loss of weight during the process, reduction of the total process time, better control over the process, elimination of discharges of contaminated water into the sewer system, less consumption of energy in comparison with state-of-the-art processes and a process safe for the equipment operator.

### LIST OF FIGURES

FIG. 1. Block diagram of the defrosting apparatus according to this invention.

FIG. 2. Heating module according to this invention.

FIG. 3. Module for controlling and monitoring variables according to this invention.

FIG. 4. Electric power module according to this invention.

FIG. 5. Pneumatic module according to this invention.

FIG. 6. General diagram of the defrosting equipment according to this invention.

FIG. 7. Relation between a material's temperature and electrical conductivity

### DESCRIPTION OF THE PREFERENTIAL MODE OF THE INVENTION

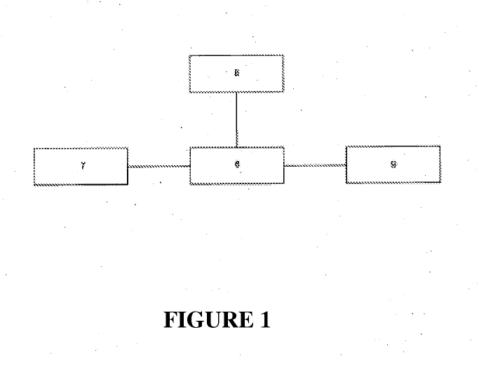

The ohmic defrosting equipment according to this invention is composed of a plurality of heating modules 6, one module for controlling and monitoring variables 7, a plurality of power modules 8 and a plurality of pneumatic modules 9. FIG. 1 illustrates the block diagram of the equipment, and each one of them is described in the paragraphs that follow.

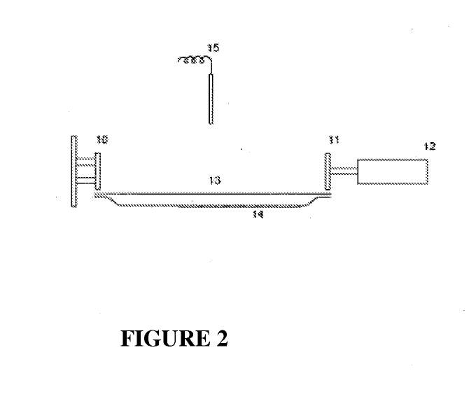

In accordance with FIG. 2, each of the heating modules 6 is equipped with: a fixed electrode 10, joined by means of an electrical insulating material to the chassis of the apparatus and which receives the frozen block of food 3; a mobile electrode 11, which is displaced by a piston 12 to apply pressure over the frozen block of food 3 and in this way to ensure good electrical contact between the electrodes and the frozen block of food 3; the piston is joined to the electrode by means of an electric insulating material; a support grill 13 made of insulating material, which keeps the block of frozen food in the correct position during the process; a drain pan 14, which receives the liquid material generated once the defrosting temperature has been achieved and a thermocouple 15, which allows monitoring the temperature of the frozen block of food 3 while it is heating.

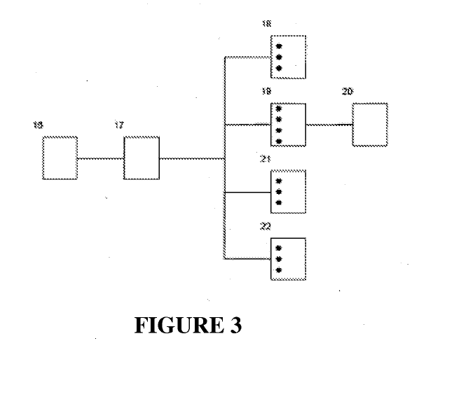

In accordance with FIG. 3, the module for controlling and monitoring of variables 7 is made up of a panel 16, which lets the operator program the operational parameters of the equipment and to know the state of the variables of interest during the operation; a PLC 17, which sends and receives the signals from all the instruments of the equipment and which is programmed with the control code for the operational conditions; a pressure transducer 18 for each of the heating modules 6, which controls the operation of piston 12; a current transformer 19 for each heating module 6, which performs control of the system using the electric current circulating through the frozen block as a control variable; a solid-state relay 20, which allows control of the circulation of the electric current by the circuit; a limit switch 21 located in the doors of each of the heating modules 6: this ensures the safety of the person who operates the equipment and performs maintenance tasks, preventing current from circulating when the door is open and ensuring that the pieces energized are within his reach, and a temperature transducer 22 for each of the heating modules 6, which receives the signals of the thermocouples 15. The system can be controlled by current instead of the temperature of the sample, thanks to the direct relation between the current that circulates through the blocks of material and their temperature.

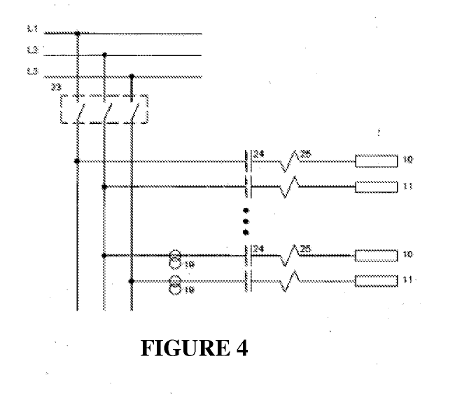

In accordance with FIG. 4, each of the power modules 8 is designed to supply the electrical energy necessary to achieve heating of the blocks of frozen material submitted to the process. This module is made up of a circuit breaker 23, which protects the equipment from short circuits; contacts 24 of the solid-state relay 20, for controlling the process; and a current-limiting resistor 25. These are connected to fixed electrodes 10 and mobile electrodes 11 of each of the heating modules 6.

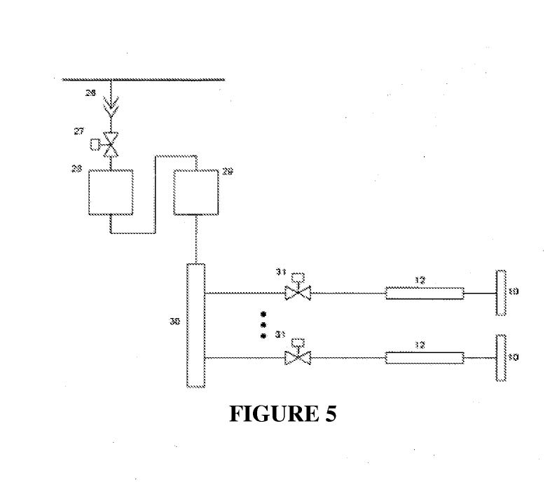

In accordance with FIG. 5, each of the pneumatic modules 9 is designed to ensure permanent contact between the electrodes of each one of the heating modules 6, fixed electrodes 10 and mobile electrodes 11, and the frozen food block 3 which has to be defrosted. This module is made up of a rapid coupler 26, which allows connection to the compressed air network; a service valve 27 for interrupting the supply of compressed air; a regulating unit 28 for controlling the pressure of the air that feeds the system; a maintenance unit 29 for guaranteeing the quality of the air; a manifold 30 for distributing the air to all the circuits that make up the equipment; an electro valve 31 for activating the pressure in each of the heating modules 6; and a piston 12 in each of the heating modules 6 for guaranteeing contact between the fixed electrodes 10 and mobile electrodes 11 with the frozen food block 3.

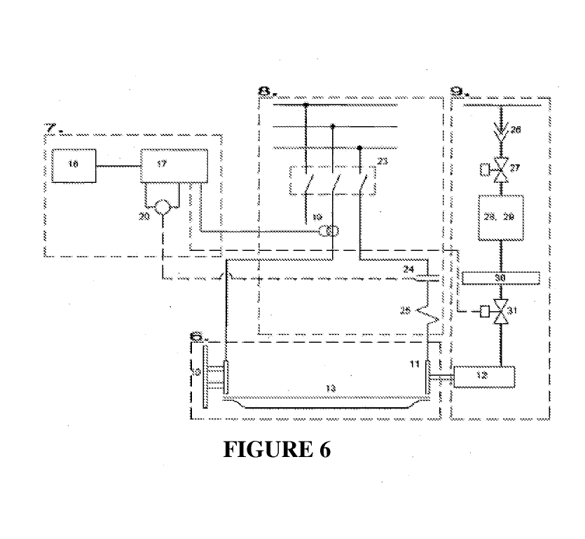

FIG. 6 shows a general diagram of the defrosting apparatus according to the present invention. Support grille 13 and fixed electrode 10 receive frozen food block 3, mobile electrode 11 guarantees a good electrical contact between fixed electrodes 10 and mobile electrodes 11 and frozen food block 3. Said mobile electrode 11 is displaced by a piston 12, which is controlled by means of a solenoid valve 26, which allows connection to the compressed air network; a service valve 27 for interrupting the supply of compressed air; a regulating unit 28 for controlling the pressure of the air that feeds the system; a maintenance unit 29 for guaranteeing the quality of the air; a manifold 30 for distributing the air to all the circuits that make up the equipment; an electro valve 31 for activating the pressure in each of the heating modules 6. Said fixed electrode 10 and mobile electrode 11 of each heating module 6 succeed in heating the frozen food blocks 3 by means of power module 6, which supplies the necessary electrical energy by means of a totalizing switch 23, which protects the equipment from short circuits; contacts of the solid state relay 24 that control the process and a current-limiting resistor 25.

The system is controlled by means of the module for controlling and monitoring of variables 7, which is made up of a panel 16 for programming the operational parameters of the equipment; a PLC 17, which sends and receives the signals from all the instruments of the equipment; a pressure transducer 18 for each of the heating modules 6 connected to the electro valve 31, which controls the operation of the piston 12; a current transformer 19 for each heating module 6, which performs control of the system using the electric current circulating through the frozen food block 3 as a control variable; a solid-state relay 20, connected to contacts of the solid state relay 24 which allows control of the circulation of the electrical current by the circuit; a limit switch 21 located in the doors of each of the heating modules 6: this ensures the safety of the person operating the equipment and performs maintenance tasks, preventing current from circulating when the door is open and the pieces energized are within its reach, and a temperature transducer 22 for each of the heating modules 6, which receives the signals of the thermocouples 15.

The process according to this invention to be implemented in the ohmic defroster which is its object comprises the following stages:

Loading stage: place frozen food block 3 in heating modules 6; program the conditions of operation appropriate for the material to be processed, using control panel 16, and activate limit switch 21.

Defrosting stage: using the pistons 12 that are part of pneumatic modules 9, put fixed electrode 10 and mobile electrode 11 in contact with frozen food blocks 3 located in each of the heating modules 6. Once contact has been ensured between frozen food block 3, fixed electrode 10 and mobile electrode 11, contact 24 of solid state relay 20 is closed and electrical current is supplied until this reaches 1.5 amperes in the circuit, at this moment contact 24 of solid state relay 20 opens; after this initial pulse of current, the material is allowed to rest for 20 minutes during which no current is supplied; after this rest a sequence of pulses is initiated to supply electrical current and periods of rest without it, controlled by means of the electrical current signal sent by current transformer 19 to PLC 17 which are part of variable control and monitoring module 7.

Each pulse of electrical current is supplied until the current in heating module 6 reaches a value of 0.3 amperes over the current value recorded prior to the rest period; at that time PLC 17 sends the signal by which contact 24 of solid state relay 20 opens and the supply of electrical current is interrupted; at this time the 20-minute rest period starts. This process is repeated until the electrical current in heating module 6 reaches 4.5 amperes, and this is when the process terminates.

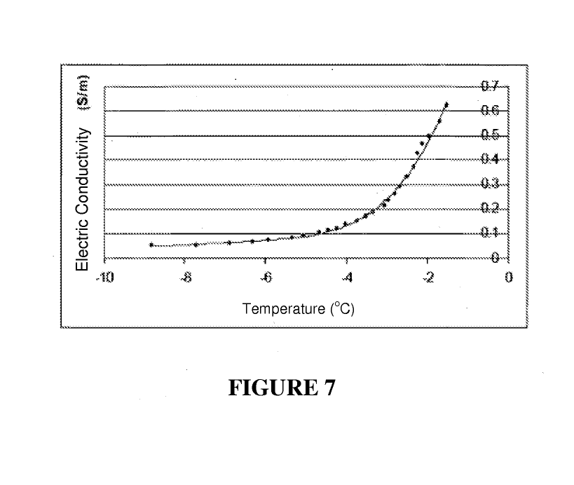

The electrical current is utilized as a control variable, while the relationship between the electrical current that circulates through the material and its temperature is direct, it is possible, knowing the composition of the material, to establish its electrical conductivity and the current that circulates at a given temperature. The higher the temperature, the higher the material's capacity to conduct the electrical current and the higher current that circulates through it. FIG. 7 shows a typical case of the relationship between temperature and electrical conductivity for a meat material rich in water.

Having described this invention, it will be better understood by referring to the following examples, which are provided as a means of illustration and are not intended to limit the present invention.

### EXAMPLES

### Experimental Protocol for Finding the Relation Between Electrical Conductivity and Temperature of the Sample of Frozen Material

Determining the capacity of each of the materials to conduct electrical current, electrical conductivity, and its relation to the change of the temperature produced in the material.

The tests were performed using samples of lean muscles of beef, pork and turkey, for each type of material three cross-sectional square samples 0.03 m wide and 0.1 m long, these samples were frozen and stored in order to homogenize their temperature at −15° C. Each of the samples was subjected to a proximal analysis to determine its composition in terms of content of fat, protein, water and ash.

During the tests, the samples were housed in a cell designed for the project, which was also homogenized at a temperature of −15° C.; this test cell, along with the sample, was connected to an electric circuit formed by a power supply regulated and adjusted to 67 volts of alternating current and 60 Hz of frequency, a voltmeter, an ammeter, a current-limiting resister and a data acquisition system for recording temperatures at three points on the axis of the sample. Current, voltage and temperature were recorded at one-minute intervals.

The measuring equipment was constructed by following the design presented by Shirsat and which is represented by the following expression (Shirsat et al., 2004):

$$k = S * \frac{l}{A}$$

Where k is electrical conductivity (S m⁻¹), S is the inverse of the electrical resistance (S), 1 is the length of the sample (m) and A is the transversal area of the sample (m²). The inverse of the resistance (S) is measured in Siemens.

Once the value of the electrical conductivity was known for each value of the sample temperature, the values were graphed, and by means of a regression line the model was found that illustrates the behavior of the electrical conductivity as a function of the sample temperature. Also, the composition of each material studied was determined by a proximal analysis and with this it was possible to establish the effect of the material's composition on its capacity to conduct electrical current and be heated.

For the proximal analysis the following procedures were followed: to determine the fat content, the method used was AOAC 964.12 (1990) “Fat (Crude) in Seafood. Rapid modified Babcock Method.” The moisture content was determined by means of the COPANT968 Meat and its products—Determination of moisture content—Reference method, and for the ash content the Fisher method was used, and the protein quantity was obtained by subtracting the amount of the other elements from the total weight of the sample.

### Experimental Protocol for Defining the Operational Parameters for Application

Defining the operational parameters and with these values defining the operational conditions for each one of the blocks.

### Materials:

Cut of pork—9 samples
Cut of bacon—9 samples
Cut of lean beef (CPM)—9 samples
Shoulder—9 samples

### Variables to be Measured:

Electrical current that circulates through the samples.
Voltage in the contact plates (electrodes)
Temperature of sample.
Duration of process.

### Procedure:

Load the blocks of meat from the test materials into the loading cell of the unit.
Measure the initial temperature of the sample.
Ensure that the door of the unit is closed and the safety microswitch turned on.
On the unit's control panel, program the parameters of the conditions of operation, using the values defined for each material
Start the defrosting process, using the panel controls.
Once the signal light goes on, indicating that the process has ended, record its final temperature and take a photograph.

### Defining the Conditions of Operation:

The conditions of operation of each material consist of:
Current limited by the initial pulse of current
Duration of the rest period
Duration of the time interval of the current
Current limit by the end of the process.

### Experimental Protocol for the Defrosting Process

Conditions of operation:

| | | |
|---|---|---|
| Operating voltage: | 220 | volts |
| Pressure in air unit: | 0.414-0483 | MPa |
| Base conditions: | | |
| Current limit initial pulse: | 3 | amperes |
| Resting time: | 30 | minutes |
| Time current supplied: | 25 | minutes |
| Current limit end of process: | 5 | amperes |
| Block size: | | |
| Length: | 0.5 | meters |
| Width: | 0.5 | meters |
| Thickness: | 0.1 | meter |

### Results

As can be seen in Table 1 which follows, it is clear that the samples of the blocks defrosted using this technological object of patent protection present less weight loss compared with the average result obtained with the traditional process, which for the industry translates into a better use of raw material. One observes a reduction in the percentage of loss from 66% to 84%, reflected in accumulated gains of up to 270 kg of raw materials. Also, this result of good use of the material is achieved with a process that is shorter, while the traditional process takes a time between 15 and 18 hours, dependent upon the material and the initial temperature of the blocks; the new process, under the same conditions, takes a time between 3.5 and 4.5 hours.

| | | | | | LOSS OF | LOSS OF | |
|---|---|---|---|---|---|---|---|
| | WEIGHT | | | | THE | THE | |
| | COMING | WEIGHT | | | STATE | STATE | |
| | IN | COMING | LOSS | | OF THE | OF THE | |
| MATERIAL | kg | OUT kg | kg | LOSS % | ART | ART | GAIN kg |
| Shoulder | 195.60 | 191.60 | 4.00 | 2.04% | 4.00% | 7.82 | 3.82 |
| Shoulder | 198.50 | 192.40 | 6.10 | 3.07% | 4.00% | 7.94 | 1.84 |
| Shoulder | 185.50 | 184.00 | 1.50 | 0.81% | 4.00% | 7.42 | 5.92 |
| Shoulder | 184.00 | 183.50 | 0.50 | 0.27% | 4.00% | 7.36 | 6.86 |
| Shoulder | 183.00 | 182.50 | 0.50 | 0.27% | 4.00% | 7.32 | 6.82 |
| Shoulder | 168.00 | 167.50 | 0.50 | 0.30% | 4.00% | 6.72 | 6.22 |
| Shoulder | 169.00 | 167.50 | 1.50 | 0.89% | 4.00% | 6.76 | 5.26 |
| Shoulder | 178.00 | 177.00 | 1.00 | 0.56% | 4.00% | 7.12 | 6.12 |
| Shoulder | 173.50 | 173.00 | 0.50 | 0.29% | 4.00% | 6.94 | 6.44 |
| Shoulder | 174.50 | 173.00 | 1.50 | 0.86% | 4.00% | 6.98 | 5.48 |
| Shoulder | 200.50 | 199.50 | 1.00 | 0.50% | 4.00% | 8.02 | 7.02 |
| Shoulder | 185.50 | 184.00 | 1.50 | 0.81% | 4.00% | 7.42 | 5.92 |
| Shoulder | 159.50 | 158.00 | 1.50 | 0.94% | 4.00% | 6.38 | 4.88 |
| Material 1 | 2.355.10 | 2.683.00 | 23.15 | 0.86% | 4.00% | 94.20 | 72.60 |
| Cut of Pork | 170.00 | 169.00 | 1.00 | 0.59% | 2.00% | 3.40 | 2.40 |
| Cut of Pork | 168.70 | 166.40 | 2.30 | 1.36% | 2.00% | 3.37 | 1.07 |
| Cut of Pork | 150.90 | 147.80 | 3.10 | 2.05% | 2.00% | 3.02 | −0.08 |
| Cut of Pork | 147.70 | 147.00 | 0.70 | 0.47% | 2.00% | 2.95 | 2.25 |
| Cut of Pork | 163.30 | 161.00 | 2.30 | 1.41% | 2.00% | 3.27 | 0.97 |
| Cut of Pork | 164.00 | 163.00 | 1.00 | 0.61% | 2.00% | 3.28 | 2.28 |
| Cut of Pork | 167.00 | 166.00 | 1.00 | 0.60% | 2.00% | 3.34 | 2.34 |
| Cut of Pork | 169.00 | 167.50 | 1.50 | 0.89% | 2.00% | 3.38 | 1.88 |
| Cut of Pork | 178.00 | 177.00 | 1.00 | 0.56% | 2.00% | 3.56 | 2.56 |
| Cut of Pork | 146.50 | 145.50 | 1.00 | 0.68% | 2.00% | 2.93 | 1.93 |
| Cut of Pork | 158.00 | 157.00 | 1.00 | 0.63% | 2.00% | 3.16 | 2.16 |
| Cut of Pork | 182.00 | 181.50 | 0.50 | 0.27% | 2.00% | 3.64 | 3.14 |
| Cut of Pork | 178.00 | 177.50 | 0.50 | 0.28% | 2.00% | 3.56 | 3.06 |
| Cut of Pork | 199.50 | 198.00 | 1.50 | 0.75% | 2.00% | 3.99 | 2.49 |
| Cut of Pork | 200.00 | 199.50 | 0.50 | 0.25% | 2.00% | 4.00 | 3.50 |
| Cut of Pork | 180.00 | 179.00 | 1.00 | 0.56% | 2.00% | 3.60 | 2.60 |
| Cut of Pork | 189.00 | 188.50 | 0.50 | 0.26% | 2.00% | 3.78 | 3.28 |
| Cut of Pork | 180.00 | 179.00 | 1.00 | 0.56% | 2.00% | 3.60 | 2.60 |
| Cut of Pork | 191.50 | 190.50 | 1.00 | 0.52% | 2.00% | 3.83 | 2.83 |
| Cut of Pork | 162.50 | 162.00 | 0.50 | 0.31% | 2.00% | 3.25 | 2.75 |
| Material 2 | 3.445.60 | 3.422.70 | 22.90 | 0.66% | 2.00% | 68.91 | 46.01 |
| | | | | | | LOSS OF | |
| | | | | | LOSS OF | THE | |
| | WEIGHT | | | | THE | STATE | |
| | E | WEIGHT | | | STATE | OF THE | |
| | COMING | COMING | LOSS | | OF THE | ART | |
| MATERIAL | IN kg | OUT kg | kg | LOSS % | ART % | kg | GAIN kg |
| Cut of Lean Beef | 187.60 | 187.00 | 0.60 | 0.32% | 3.00% | 5.63 | 5.03 |
| Cut of Lean Beef | 206.50 | 206.00 | 0.50 | 0.24% | 3.00% | 6.20 | 5.70 |
| Cut of Lean Beef | 174.50 | 173.00 | 1.50 | 0.86% | 3.00% | 5.24 | 3.74 |
| Cut of Lean Beef | 175.00 | 174.50 | 0.50 | 0.29% | 3.00% | 5.25 | 4.75 |
| Cut of Lean Beef | 182.50 | 181.50 | 1.00 | 0.55% | 3.00% | 5.48 | 4.48 |
| Cut of Lean Beef | 109.00 | 108.00 | 1.00 | 0.92% | 3.00% | 3.27 | 2.27 |
| Cut of Lean Beef | 111.00 | 110.00 | 1.00 | 0.90% | 3.00% | 3.33 | 2.33 |
| Cut of Lean Beef | 159.80 | 158.50 | 1.30 | 0.81% | 3.00% | 4.79 | 3.49 |
| Cut of Lean Beef | 73.50 | 72.50 | 1.00 | 1.36% | 3.00% | 2.21 | 1.21 |
| Cut of Lean Beef | 162.50 | 161.00 | 1.50 | 0.92% | 3.00% | 4.88 | 3.38 |
| Cut of Lean Beef | 153.80 | 153.00 | 0.80 | 0.52% | 3.00% | 4.61 | 3.81 |
| Cut of Lean Beef | 198.00 | 196.50 | 1.50 | 0.76% | 3.00% | 5.94 | 4.44 |
| Cut of Lean Beef | 195.50 | 194.00 | 1.50 | 0.77% | 3.00% | 5.87 | 4.37 |
| Cut of Lean Beef | 204.50 | 203.50 | 1.00 | 0.49% | 3.00% | 6.14 | 5.14 |
| Cut of Lean Beef | 210.00 | 209.50 | 0.50 | 0.24% | 3.00% | 6.30 | 5.80 |
| Cut of Lean Beef | 223.00 | 222.00 | 1.00 | 0.45% | 3.00% | 6.69 | 5.69 |
| Cut of Lean Beef | 209.00 | 208.50 | 0.50 | 0.24% | 3.00% | 6.27 | 5.77 |
| Cut of Lean Beef | 214.50 | 213.00 | 1.50 | 0.70% | 3.00% | 6.44 | 4.94 |
| Cut of Lean Beef | 217.50 | 217.00 | 0.50 | 0.23% | 3.00% | 6.53 | 6.03 |
| Cut of Lean Beef | 201.50 | 200.50 | 1.00 | 0.50% | 3.00% | 6.05 | 5.05 |
| Cut of Lean Beef | 201.00 | 200.50 | 0.50 | 0.25% | 3.00% | 6.03 | 5.53 |
| Cut of Lean Beef | 198.00 | 197.00 | 1.00 | 0.51% | 3.00% | 5.94 | 4.94 |
| Cut of Lean Beef | 196.50 | 195.00 | 1.50 | 0.76% | 3.00% | 5.90 | 4.40 |
| Cut of Lean Beef | 207.00 | 206.00 | 1.00 | 0.48% | 3.00% | 6.21 | 5.21 |
| Cut of Lean Beef | 204.80 | 204.00 | 0.80 | 0.39% | 3.00% | 6.14 | 5.34 |
| Cut of Lean Beef | 206.50 | 206.00 | 0.50 | 0.24% | 3.00% | 6.20 | 5.70 |
| Cut of Lean Beef | 198.50 | 197.20 | 1.30 | 0.65% | 3.00% | 5.96 | 4.65 |
| Cut of Lean Beef | 206.00 | 205.00 | 1.00 | 0.49% | 3.00% | 6.18 | 5.18 |
| Cut of Lean Beef | 206.50 | 205.00 | 1.50 | 0.73% | 3.00% | 6.20 | 4.70 |
| Cut of Lean Beef | 215.00 | 213.50 | 1.50 | 0.70% | 3.00% | 6.45 | 4.95 |
| Cut of Lean Beef | 200.00 | 199.50 | 0.50 | 0.25% | 3.00% | 6.00 | 5.50 |
| Cut of Lean Beef | 200.00 | 199.00 | 1.00 | 0.50% | 3.00% | 6.00 | 5.00 |
| Cut of Lean Beef | 208.20 | 208.00 | 0.20 | 0.10% | 3.00% | 6.25 | 6.05 |
| Cut of Lean Beef | 184.30 | 184.00 | 0.30 | 0.16% | 3.00% | 5.53 | 5.23 |
| Cut of Lean Beef | 208.00 | 207.00 | 1.00 | 0.48% | 3.00% | 6.24 | 5.24 |
| Cut of Lean Beef | 217.00 | 214.00 | 3.00 | 1.36% | 3.00% | 6.51 | 3.51 |
| Cut of Lean Beef | 210.80 | 209.00 | 1.80 | 0.85% | 3.00% | 6.32 | 4.52 |
| Cut of Lean Beef | 221.00 | 220.00 | 1.00 | 0.45% | 3.00% | 6.63 | 5.63 |
| Cut of Lean Beef | 218.00 | 217.00 | 1.00 | 0.46% | 3.00% | 6.54 | 5.54 |
| Cut of Lean Beef | 215.00 | 214.00 | 1.00 | 0.47% | 3.00% | 6.45 | 5.45 |
| Cut of Lean Beef | 229.80 | 227.50 | 2.30 | 1.00% | 3.00% | 6.89 | 4.59 |
| Cut of Lean Beef | 166.50 | 165.40 | 1.10 | 0.66% | 3.00% | 5.00 | 3.90 |
| Cut of Lean Beef | 157.50 | 157.00 | 0.50 | 0.30% | 3.00% | 5.03 | 4.53 |
| Cut of Lean Beef | 160.60 | 160.00 | 0.60 | 0.37% | 3.00% | 4.82 | 4.22 |
| Cut of Lean Beef | 213.70 | 213.00 | 0.70 | 0.33% | 3.00% | 5.41 | 5.71 |
| Cut of Lean Beef | 158.80 | 158.00 | 0.80 | 0.50% | 3.00% | 4.76 | 3.96 |
| Cut of Lean Beef | 207.00 | 206.00 | 1.00 | 0.48% | 3.00% | 6.21 | 5.21 |
| Cut of Lean Beef | 208.50 | 207.00 | 1.50 | 0.72% | 3.00% | 6.26 | 4.76 |
| Cut of Lean Beef | 204.00 | 203.00 | 1.00 | 0.49% | 3.00% | 6.12 | 5.12 |
| Cut of Lean Beef | 198.50 | 198.00 | 0.50 | 0.25% | 3.00% | 5.96 | 5.46 |
| Cut of Lean Beef | 206.00 | 205.00 | 1.00 | 0.49% | 3.00% | 6.18 | 5.18 |
| Cut of Lean Beef | 107.00 | 106.50 | 0.50 | 0.47% | 3.00% | 3.21 | 2.71 |
| Cut of Lean Beef | 210.00 | 209.00 | 1.00 | 0.48% | 3.00% | 6.30 | 5.30 |
| Cut of Lean Beef | 210.00 | 209.50 | 0.50 | 0.24% | 3.00% | 6.30 | 5.80 |
| Cut of Lean Beef | 164.00 | 163.00 | 1.00 | 0.61% | 3.00% | 4.92 | 3.92 |
| Cut of Lean Beef | 163.50 | 163.00 | 0.50 | 0.31% | 3.00% | 4.91 | 4.41 |
| Cut of Lean Beef | 160.00 | 159.00 | 1.00 | 0.63% | 3.00% | 4.80 | 3.80 |
| Cut of Lean Beef | 165.50 | 158.00 | 7.50 | 4.53% | 3.00% | 4.97 | −2.54 |
| Cut of Lean Beef | 207.00 | 205.80 | 1.20 | 0.58% | 3.00% | 6.21 | 5.01 |
| Material 3 | 11.199.20 | 11.133.90 | 15.10 | 0.13% | 3.00% | 335.98 | 270.68 |
| | | | | | LOSS OF | LOSS OF | |
| | | | | | THE | THE | |
| | | | | | STATE | STATE | |
| | WEIGHT | WEIGHT | | | OF THE | OF THE | |
| | COMING | COMING | LOSS | | ART | ART | |
| MATERIAL | IN kg | OUT kg | kg | LOSS % | % | kg | GAIN kg |
| Shoulder | 188.00 | 187.50 | 0.50 | 0.27% | 3.00% | 5.64 | 5.14 |
| Shoulder | 199.50 | 198.50 | 1.00 | 0.50% | 3.00% | 5.99 | 4.99 |
| Shoulder | 195.20 | 194.00 | 1.20 | 0.61% | 3.00% | 5.86 | 4.66 |
| Shoulder | 148.50 | 147.50 | 1.00 | 0.67% | 3.00% | 4.46 | 3.46 |
| Shoulder | 146.50 | 146.00 | 0.50 | 0.34% | 3.00% | 4.40 | 3.90 |
| Shoulder | 202.00 | 201.00 | 1.00 | 0.50% | 3.00% | 6.06 | 5.06 |
| Shoulder | 197.00 | 196.00 | 1.00 | 0.51% | 3.00% | 5.91 | 4.91 |
| Material 4 | 1.276.70 | 1.270.50 | 6.20 | 0.49% | 3.00% | 38.30 | 32.10 |
| | | | | | LOSS OF | LOSS OF | |
| | | | | | THE | THE | |
| | | | | | STATE | STATE | |
| | WEIGHT | WEIGHT | | | OF THE | OF THE | GANANCIA |
| | COMING | COMING | LOSS | | ART | ART | GAIN |
| MATERIAL | IN kg | OUT kg | kg | LOSS % | % | kg | kg |
| CPM Ham | 206.50 | 205.00 | 1.50 | 0.73% | 3.00% | 6.20 | 4.70 |
| CPM Ham | 145.00 | 144.50 | 0.50 | 0.34% | 3.00% | 4.35 | 3.85 |
| CPM Ham | 169.00 | 167.50 | 1.50 | 0.89% | 3.00% | 5.07 | 3.57 |
| CPM Ham | 209.50 | 208.50 | 1.00 | 0.48% | 3.00% | 6.29 | 5.29 |
| CPM Ham | 191.00 | 190.00 | 1.00 | 0.52% | 3.00% | 5.73 | 4.73 |
| CPM Ham | 199.00 | 197.50 | 1.50 | 0.75% | 3.00% | 5.97 | 4.47 |
| CPM Ham | 199.50 | 198.00 | 1.50 | 0.75% | 3.00% | 5.99 | 4.49 |
| CPM Ham | 200.50 | 198.00 | 2.50 | 1.25% | 3.00% | 6.02 | 3.52 |
| CPM Ham | 199.00 | 198.00 | 1.00 | 0.50% | 3.00% | 5.97 | 4.97 |
| CPM Ham | 196.50 | 195.00 | 1.50 | 0.76% | 3.00% | 5.90 | 4.40 |
| CPM Ham | 75.00 | 74.50 | 0.50 | 0.67% | 3.00% | 2.25 | 1.75 |
| Material 5 | 1.990.50 | 1.975.50 | 14.00 | 0.70% | 3.00% | 59.72 | 45.72 |

The percentage value of loss in the state of the art is equivalent to the average value of the values gathered in the implementations of the traditional process. They were taken from the operating records kept during the operation in the production plant.

1. Ohmic defrosting equipment for blocks of frozen foods consisting of:
(a) Heating modules;
(b) Control and monitoring modules;
(c) Power modules; and
(d) Pneumatic modules.
Where said heating modules are made up of a fixed electrode connected to the chassis of the equipment; a mobile electrode displaced by a piston to ensure a good electric contact between the electrodes and the frozen material; a support grille; a drain pan and a thermocouple which allows monitoring of the temperature of the frozen material while it is heating.

2. The defrosting equipment according to claim 1, characterized in that the control and monitoring module comprises a panel; a PLC; a pressure current transducer for each heating module, which controls the operation of the piston; a current transformer for each heating module; a solid state relay; a limiting switch located in the doors of each of the heating modules and a temperature transducer for each of the heating modules, which receives signals from the thermocouples.

3. The defrosting equipment according to claim 1, characterized in that the power modules comprise a circuit breaker; contacts of the solid state relay and a current-limiting resistor connected to the fixed and mobile electrodes of the heating modules.

4. The defrosting equipment according to claim 1, characterized in that the pneumatic modules are designed to guarantee permanent contact between the fixed and mobile electrodes of the heating modules and the frozen material and comprise a rapid coupler; a service valve; a regulating unit; a maintenance unit; a manifold; an electro valve and a piston for each heating module.

5. The defrosting equipment according to claim 1, characterized in that the fixed electrode is connected to the chassis by means of an electric insulating material.

6. The defrosting equipment according to claim 1, characterized in that the piston is joined to the mobile electrode by means of an electric insulating material.

7. The defrosting equipment according to claim 1, characterized in that the supporting grille is made of an insulating material.

8. The defrosting equipment according to claim 1, characterized in that it is equipped with a single control and monitoring module which governs its entire operation.

9. The defrosting equipment according to claim 8, characterized in that the system can be controlled by the current or the temperature of the sample.

10. A process for defrosting blocks of frozen food, characterized in that:
I. The frozen food block is placed in the heating modules;
II. The fixed and mobile electrodes are put into contact with the frozen food blocks by means of the piston;
III. The contact of the solid state relay is closed and electric current is supplied until it reaches 1.5 amperes in the circuit;
IV. The frozen food block is allowed to rest for 20 minutes;
V. Pulses of electric current and periods of rest without current are supplied sequentially.

11. The process according to claim 10, characterized in that in stage V, each pulse of electric current is supplied until the current in the heating module reaches a value of 0.3 amperes over the value of current recorded prior to the rest period.

12. The process according to claim 10, characterized in that in stage V, each rest period is 20 minutes long.

13. The process according to claim 10, characterized in that stage V is repeated until the electric current in the heating module reached 4.5 amperes.

14. The process according to claim 10, characterized in that it is controlled by means of the electric current signal.
